(19) United States
(12) Patent Application Publication
(10) Pub. No.: US 2026/0131599 A1
(43) Pub. Date: May 14, 2026

(54) FLEXURE MEMBER FOR NON-PNEUMATIC TIRE SPOKE COMPONENT

(71) Applicant: BRIDGESTONE AMERICAS TIRE OPERATIONS, LLC, NASHVILLE, TN (US)

(72) Inventors: Andrew V. Haidet, Akron, OH (US); Benjamin E. Rimai, Akron, OH (US); Bradley S. Plotner, Akron, OH (US); Zachary G. Lorenz, Akron, OH (US)

(21) Appl. No.: 19/118,130

(22) PCT Filed: Sep. 27, 2023
(86) PCT No.: PCT/US2023/075200

§ 371 Date: Apr. 3, 2025

Related U.S. Application Data
(60) Provisional application No. 63/419,488, filed on Oct. 26, 2022.

(51) Int. Cl. B60C 7/14

(52) U.S. Cl. CPC B60C 7/146

(57) ABSTRACT

A non-pneumatic tire that includes an inner support ring positioned within and coaxial to an outer support ring with a support structure connecting the rings to one another. The support structure includes a plurality of spokes that are secured to the inner support ring and the outer support ring. A flexure member having a filleted perimeter surface is used to attach an end of the spokes to the outer support ring.

### TECHNICAL FIELD

The present disclosure relates to a flexure member for a spoke component of a non-pneumatic tire and, in particular, to a flexure member having radiused perimeter edges for attaching an end of a spoke component to a support ring of a non-pneumatic tire.

### BACKGROUND

Non-pneumatic tire constructions enable a tire to operate in a non-inflated condition and do not require inflation. Non-pneumatic tires may include support structures, such as spokes or webbing, that provide a compression zone and attach an inner support ring to an outer support ring. The inner support ring is positioned near the hub and the outer support ring can incorporate and attached circumferential tread.

The ends of spokes for non-pneumatic tires are attached to the inner and outer support rings. During operation of the tire, the spokes and compress and stretch and cause the ends of the spokes to deflect with respect to one another, which can create stress in the spoke. The spoke end attached to the outer support ring near the tread portion of the tire receives forces from the tread portion as the tire rolls over ground surfaces and cause the spoke end to flex and generate stresses at attachment points.

The present invention aims to reduce stresses imparted at attachment points at spoke ends and in some instances reorient stresses away from bonding areas between surfaces to improve the durability of an attachment point.

### SUMMARY

In a first aspect, disclosed is a non-pneumatic tire that includes an outer support ring, an inner support ring positioned inside the outer support ring, a support structure positioned between the outer support ring and the inner support ring such that the support structure includes a spoke and the spoke has a first end secured to the inner support ring and a second end secured to a flexure member, the flexure member having an inner surface, an outer surface, and a perimeter surface, the entire perimeter surface being filleted or at least two or more faces being filleted.

In one example of aspect 1, the inner surface of the flexure member is secured to the second end of the spoke and the outer surface of the flexure member is secured to the outer support ring for securing the second end of the spoke to the outer support ring.

In another example of aspect 1, the filleted perimeter surface is positioned between, and intersects and is in contact with, the inner surface and the outer surface of the flexure member.

In another example of aspect 1, the flexure member is positioned between the second end of the spoke and the outer support ring, and the second end of the spoke is free of contact with the outer support ring.

In another example of aspect 1, the filleted perimeter surface has a concave shape.

In another example of aspect 1, the concave shape of the filleted perimeter surface is continuous without a flat linear plane portion, and the filleted perimeter surface extends from the intersection with the inner surface to the intersection with the outer surface. In another example, the concave shape of the filleted perimeter surface can include a flat linear portion, for instance, at or near a center waist portion of the filleted perimeter surface.

In another example of aspect 1, the concave shape of the filleted perimeter surface has a circular radius, elliptical arc, or a combination thereof.

In another example of aspect 1, the filleted perimeter surface includes substantially all, and in an example the entirety, of the outer surface of the flexure member positioned between the inner surface and the outer surface of the flexure member, and the filleted perimeter surface of the flexure member has two or more faces having a filleted surface. The two or more faces are positioned to face in opposite directions from one another. In another example, the two or more faces each face in a direction not the same as or aligned with another face.

In another example of aspect 1, the filleted perimeter surface of the flexure member is comprised of four or more faces having a filleted surface. In another example, the four or more faces each face in a direction not the same as or aligned with another face.

In another example of aspect 1, the two or more, three or more, or four or more faces of the filleted perimeter surface of the flexure member intersect with one another, or intersect with another perimeter face surface, to form one or more corners along the filleted perimeter surface, the one or more corners of the filleted perimeter surface being a filleted corner face.

The filleted corner face or faces can face in a direction that is not the same as or aligned with any other perimeter face surface.

In a second aspect, there is disclosed a flexure member for a non-pneumatic tire, the flexure member includes an inner surface, the inner surface can have a linear plane, curved plane or other shape, for example, a plane matching a spoke end surface, an outer surface, the outer surface can have a linear plane, curved plane or other shape, for example, a plane matching an outer support ring surface, and a side perimeter surface arranged between the inner surface and the outer surface, the side surface extending around the entire perimeter of the flexure member, the perimeter side surface having two or more radiused face surfaces. The two or more radiused face surfaces do not face in the same direction as one another.

In one example of aspect 2, the plane (e.g., linear, curved) of the inner surface has a perimeter defined by a plurality of perimeter edges that form two or more, three or more, or four or more connection points or corners where the perimeter edges intersect one another, and the two or more, three or more, or four or more connection points or corners along the linear plane of the inner surface are in contact with a portion of a radiused concave surface of the side perimeter surface of the flexure member.

In another example of aspect 2, the plane (e.g., linear, curved) of the outer surface has a perimeter defined by a plurality of perimeter edges that form two or more, three or more, or four or more connection points or corners where the perimeter edges intersect one another, and two or more, three or more, or four or more connection points or corners along the linear plane of the outer surface are in contact with a portion of a radiused concave surface of the side perimeter surface of the flexure member.

In another example of aspect 2, the two or more radiused concave surfaces have a circular shape, an elliptical shape, a parabolic shape, or a combination thereof.

In another example of aspect 2, the two or more radiused face surfaces are concave surfaces.

In another example of aspect 2, the two or more radiused face surfaces each include a first or bottom end and a second or top end, the first end intersects with a perimeter edge of the inner surface of the flexure member and the second end intersects with a perimeter edge of the outer surface of the flexure member.

In another example of aspect 2, the side perimeter surface includes four face surfaces that define the entire or substantially the entire perimeter, for example except for filleted or concave corner surfaces of the perimeter, of the flexure member between the inner surface and the outer surface, each of the four face surfaces have a concave shape and intersect to form four corners along the side perimeter surface, the four corners of the side perimeter surface each being a filleted or concave corner side perimeter face.

In another example of aspect 2, the four face surfaces are radiused. The four corners can have a concave or convex radiused surface, for instance, the same or similar shape to one or more of the four face surfaces of the side perimeter of the flexure member.

In another example of aspect 2, the inner surface of the flexure member is secured to a spoke of the non-pneumatic tire. The inner surface can be positioned to face or be directed radially inward to the center portion of a non-pneumatic tire.

In another example of aspect 2, the outer surface of the flexure member is secured to an outer support ring of the non-pneumatic tire. The outer surface can be positioned to face or be directed radially outward from the center portion of a non-pneumatic tire or towards an outer support ring.

In a third aspect, there is disclosed a flexure member for a non-pneumatic tire, the flexure member includes an inner surface having a plane, an outer surface having a plane, and a side perimeter surface arranged between the inner surface and the outer surface, the side surface extending around the entire perimeter of the flexure member, the perimeter side surface having two or more, three or more, or four or more radiused face surfaces that curve inward from the perimeter edge of the inner surface, the outer surface or both the inner and outer surface of the flexure member. The two or more, three or more, or four or more radiused face surfaces do not face in the same direction as one another.

In an example of aspect 3, the two, three or four or more radiused face surfaces of the flexure member form a concave section around a portion of the side perimeter, and the radiused face surfaces have a filler material in the concave section. The filler material is a different material than the material that forms the flexure member. In an example, the filler material has a lower stiffness as compared to the stiffness of the material that forms the flexure member.

In another example of aspect 3, the filler material in the concave section around a portion of the side perimeter does not extend beyond the perimeter edge of the inner surface, the perimeter edge of the outer surface or the perimeter edge of both the inner and outer surface of the flexure member.

In another example of aspect 3, the filler material occupies the entire or substantially all of the concave section around the perimeter side surface of the flexure member.

In another example of aspect 3, the filler material forms a linear or flat surface on the perimeter side surface of the flexure member. The linear or flat surface formed by the filler material in the concave section extends from a perimeter edge of the inner surface to a perimeter edge of the outer surface of the flexure member.

In another example of aspect 3, the filler material in the concave section extends outward or past a perimeter edge of the inner surface, a perimeter edge of the outer surface, or both surfaces of the flexure member.

In another example of aspect 3, the filler material forms a layer on the side perimeter surface of the flexure member.

In a fourth aspect, there is disclosed a flexure member for a non-pneumatic tire, the flexure member includes one of a mold parting line, a witness mark, a mold venting mark, a flashing, or other surface imperfection created during a molding process used to make the flexure member such that one or more of the mold parting line, witness mark, mold venting mark, flashing, or other surface imperfection is spaced away from any corner side perimeter face area or filleted corner side perimeter face area.

In an example of aspect 4, the corner side perimeter faces or filleted corner side perimeter faces, which are formed by the intersection of side perimeter faces or surfaces, of the flexure member are free of one or more of a mold parting line, a witness mark, a mold venting mark, a flashing, or other surface imperfection created during a molding process.

In another example of aspect 4, any mold parting line, witness mark, mold venting mark, flashing and/or surface imperfection mark present on the outer surface of the flexure member is spaced away from the corner side perimeter faces or filleted corner side perimeter faces by at least 5 millimeters (mm), at least 8 mm, at least 10 or at least 15 mm.

In another example of aspect 4, any mold parting line, witness mark, mold venting mark, flashing and/or surface imperfection mark present on the outer surface of the flexure member is located between or substantially centered between two corner side perimeter faces, for instance, on a perimeter surface or filleted surface of the flexure member.

The above aspects (or examples of those aspects) may be provided alone or in combination with any one or more of the examples of that aspect or another aspect discussed above; e.g., the first aspect may be provided alone or in combination with any one or more of the examples of the first aspect, second aspect, third aspect or other aspects discussed above.

Additional features and advantages will be set forth in the detailed description which follows, and in part will be readily apparent to those skilled in the art from that description or recognized by practicing the embodiments as described herein, including the detailed description which follows, the claims, as well as the appended drawings.

### BRIEF DESCRIPTION OF THE DRAWINGS

The present disclosure is better understood when the following detailed description is read with reference to the accompanying drawings.

FIG. 1 shows a side view of one embodiment of a non-pneumatic tire.

FIG. 2 shows a cross-sectional view along line 3-3 of FIG. 1.

FIG. 3 shows a side detail view of Section A of FIG. 1 with some features removed for clarity.

FIG. 4 is a detail view of a single spoke and a flexure member of a non-pneumatic tire.

FIG. 5 shows a perspective view of a flexure member attaching a spoke end to a support member of a non-pneumatic tire.

FIG. 6 shows a rear view of the flexure member of FIG. 5.

FIG. 7 shows a side view of the flexure member of FIG. 5.

FIG. 8 shows a side view of an example of a flexure member having filler material that occupies the concave section of the side perimeter of the flexure member.

### DETAILED DESCRIPTION

The terminology as set forth herein is for description of the embodiments only and should not be construed as limiting the invention as a whole.

Herein, when a range such as 5 -25 (or 5 to 25) is given, this means preferably at least or more than 5 and, separately and independently, preferably not more or less than 25. In an example, such a range defines independently 5 or more, and separately and independently, 25 or less The following includes definitions of selected terms employed herein. The definitions include various examples or forms of components that fall within the scope of a term and that may be used for implementation. The examples are not intended to be limiting. Both singular and plural forms of terms may be within the definitions.

“Axial” and “axially” refer to a direction that is parallel to the axis of rotation of a tire.

“Circumferential” and “circumferentially” refer to a direction extending along the perimeter of the surface of the tread perpendicular to the axial direction.

“Radial” and “radially” refer to a direction perpendicular to the axis of rotation of a tire.

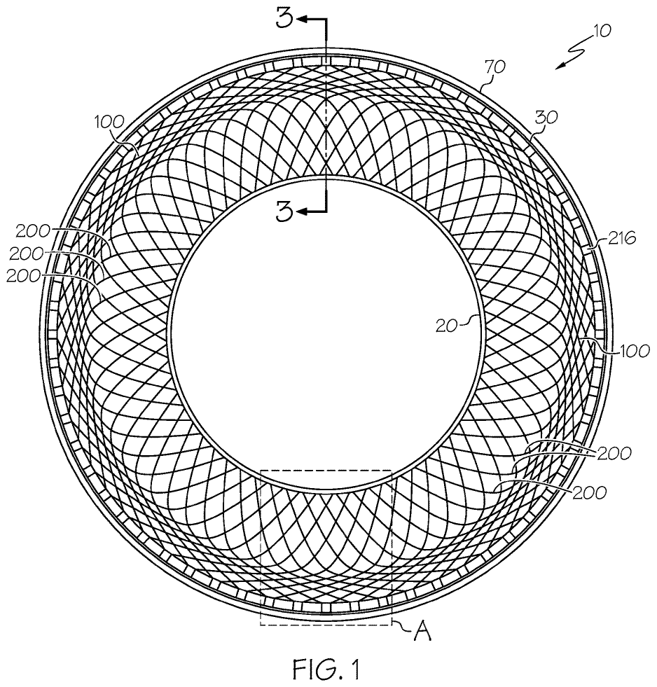

FIGS. 1 through 3 illustrate an embodiment of a non-pneumatic tire 10. The non-pneumatic tire 10 is an exemplary illustration and is not intended to be limiting. Non-pneumatic tire 10, along with other embodiments of non-pneumatic tires in the figures, can be used in a wheel for a vehicle or other related items, for example, cars, trucks, heavy-duty vehicles, trailers, all-terrain vehicles, off-road vehicles, buses, aircraft, tractors, motorcycles, bicycles and any other type of passenger vehicle.

Non-pneumatic tire 10 includes an inner support ring 20. Inner support ring 20 may engage or be in direct contact with a vehicle hub (not shown) for securing tire 10 to a vehicle or related item. The inner support ring 20 has an internal surface 23 that faces radially inward and an external surface 24 that faces radially outward, and may be made of a polymeric material, an elastomeric material, a metal, a composite material made up of polymers or resins reinforced with glass or carbon fibers, or any other suitable material or combination of materials.

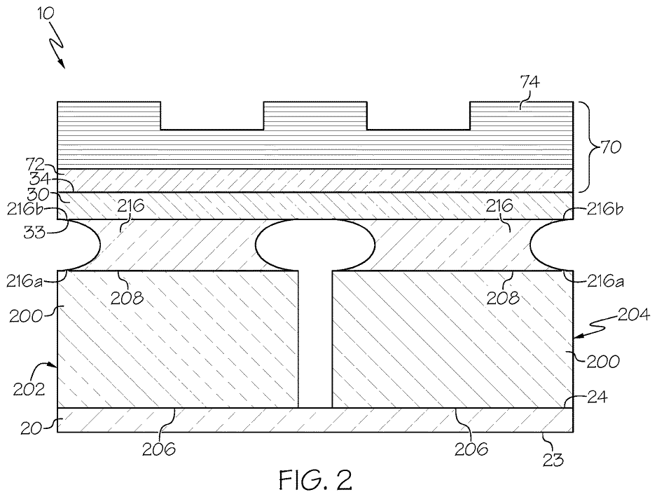

Non-pneumatic tire 10 can include an annular outer support ring 30 positioned radially outward from inner support ring 20 and components positioned between both rings 20, 30. Outer support ring 30 has a diameter, measured along internal surface 33, greater than the diameter of inner support ring 20, measured along internal surface 23, and can be, as shown, aligned and coaxial with inner support ring 20. As shown in FIG. 2, outer support ring 30 has an internal surface 33 that faces radially inward and an external surface 34 that faces radially outward, and may be made from a polymeric material, an elastomeric material, a metal, a composite material made up of polymers or resins reinforced with glass or carbon fibers, or any other suitable material or combination of materials. A circumferential tread 70 is attached to external surface 34 of outer support ring 30. Circumferential tread 70 may be attached to outer support ring 30 adhesively, mechanically, or by any other suitable arrangement. As shown, the internal surface facing radially inward of circumferential tread 70 can be in direct contact with external surface 34 of outer support ring 30.

As shown in FIG. 2, circumferential tread 70 includes a tread band 72 and a tread layer 74. Tread band 72 can be directly adhered or in contact with external surface 34. Tread band 72 and tread layer 74 may be made of out of the same material or different material. Tread layer 74 may be made out of rubber, and may include tread elements (not shown) such as grooves, ribs, blocks, lugs, sipes, studs, or any other desired tread elements. Tread band 72 may include a filament assembly.

As also shown in FIG. 2, tread band 72 can be a single layer. In alternative embodiments, tread band 72 may be a multi-layer band. Such multi-layer tread bands may include one or more layers of either a substantially inextensible or extensible material. The layers may be formed of sheets of material, cords of material, filaments of material, or any other desired arrangement. In the illustrated embodiment, the tread band 72 is shown as a single layer. In alternative embodiments, the tread band may be a multi-layer band. Such multi-layer tread bands may include one or more layers of substantially inextensible material. The layers may be formed of sheets of material, cords of material, filaments of material, or any other desired arrangement. In other alternative embodiments, the multi-layer tread band may include a layer of extensible material, such as an elastomer. According to one example embodiment, the tread band may include a pair of inextensible layers separated by a layer of extensible material. In still other alternative embodiments, the tread band may include bands that are referred to as shear bands, shear elements, or thin annular high strength band elements.

Positioned radially inward from circumferential tread 70 and outer support ring 30 is support structure 100. Support structure 100, as shown in FIG. 1, for example, includes one or more spokes 200, and connects inner support ring 20 to outer support ring 30. As shown in FIGS. 1 and 2, support structure 100 extends from external surface 24 of inner support ring 20 to internal surface 33 of outer support ring 30, and is made up of a plurality of individual spokes 200. The plurality of spokes 200 can be arranged into one or two axially spaced spoke groups, and two axially spaced spoke groups can include, as shown, a first spoke group 202 and a second spoke group 204 axially spaced from the first spoke group 202. In an alternative arrangement, the support structure may include more than two axially spaced spoke groups, for instance, three, four or more groups.

First spoke group 202 and second spoke group 204 of FIG. 2 are spaced apart from one another in the axial direction, which can be at any suitable distance and to ensure spokes from each group or plurality of groups do not contact one another. Spoke groups can be arranged such that each spoke 200 of first spoke group 202 is substantially convex relative to a clockwise circumferential direction of non-pneumatic tire 10, and each spoke of the second spoke group 204 is substantially concave relative to the clockwise circumferential direction of non-pneumatic tire 10, or vice versa is desired.

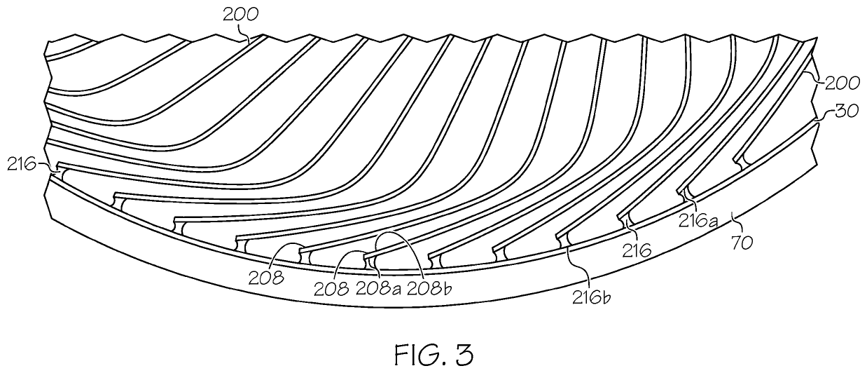

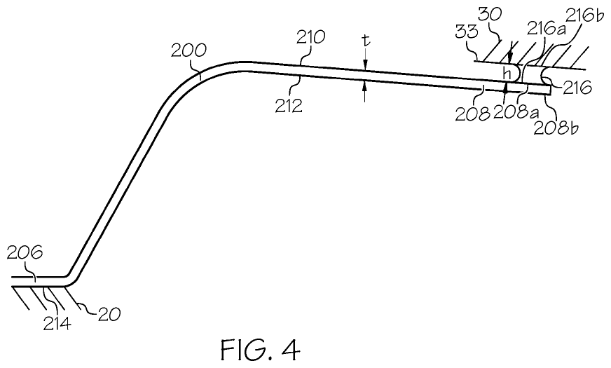

Spokes 200 may be manufactured out of metals such as steel or aluminum, polymers such as polyester or nylon, composites such as fiberglass or carbon fiber reinforced polymers, or any other suitable material or combination of materials. Spokes 200 may be provided with reinforcements (not shown), for example, metal wires, metal or fiber cords, chopped fibers, reinforcement filler, and combinations thereof. Spokes 200 shown in FIG. 4 extend radially between a first end 206 and a second end 208, and have a substantially rectangular cross section that includes a first surface 210 and a second surface 212 facing opposite the first surface 210. A spoke thickness t refers to the distance between the first and second surfaces 210, 212. In the illustrated embodiment of FIGS. 3 and 4, spokes 200 have a constant thickness between the first end 206 and the second end 208. In alternative embodiments, the thickness of a spoke may vary between the first and second ends. For example, the spoke may have relatively thicker portions at the first and second ends and a relatively thinner portion between the ends. In other alternative embodiments, a spoke may have any desired cross section shape (e.g., circle, diamond, hexagon, etc.) or may have a combination of different cross section shapes.

A flexure member 216 is provided at the second end 208 of spokes 200 for securing spokes 200 to a surface (e.g., internal surface 33) of the outer support ring 30. As shown in FIGS. 3 and 4, flexure member 216 is positioned between, for example fixed or secured between, second end 208 of spoke 200 and outer support ring 30. Second end 208 of spoke 200 is shown with a first surface 208a and a second surface 208b. Depending on the orientation of spoke 200, first surface 208a faces radially outward towards outer support ring 30 and provides a surface for flexure member 216 to contact spoke 200 and attach second end 208 of the spoke to outer support ring 30.

Flexure member 216, as arranged relative to the radial direction of non-pneumatic tire 10, includes an inner surface 216a and an outer surface 216b. Inner surface 216a of flexure member 216, facing radially inward towards inner support ring 20 and spoke 200 and forming a plane surface contoured (e.g., linear, curved) to match first surface 208a, is secured to first surface 208a of second end 208. Outer surface 216b of flexure member 216, facing radially outward toward outer support ring 30 and forming a plane surface contoured (e.g., linear, curved) to match internal surface 33, is secured to internal surface 33 of outer support ring 30. Inner surface 216a and outer surface 216b can be secured to another surface by any suitable means, for example, with a mechanical fastener, weld, or adhesive. When using an adhesive, the inner and outer surfaces 216a, 216b of the flexure member and/or the spoke and outer support ring can be cleaned to remove debris, mold release material, or other surface compounds that may reduce bonding between the surfaces. Adhesive can be applied to exposed surfaces that are to secured to one another. For instance, adhesive can be applied to the inner or outer surfaces of the flexure member, second end of a spoke, outer support ring, or any combination thereof. The adhesive can be any suitable adhesive for securing the surfaces to one another, such as an epoxy, hot-melt adhesive and the like. An example epoxy adhesive may include, but is not limited to, Chemlok® ® adhesives and/or primers. In another example, a primer material can be applied to exposed surfaces to enhance bonding of the surfaces.

Inner surface 216a and outer surface 216b have perimeter edges that define the outer profile or entire perimeter of surfaces 216a, 216b. In one or more embodiments, the inner and outer surfaces 216a, 216b each have four perimeter edges that consist of two circumferential perimeter edges and two axial perimeter edges. The perimeter edges of the inner and outer surfaces 216a, 216b form corners or connection points that are in contact with a top or bottom edge of a filleted or radiused side perimeter surface. For contacting or being secured to first surface 208a of second end 208, one or more perimeter edges of inner surface 216a can be aligned or flush with perimeter edges of the first surface 208a of second end 208. For example, the circumferential perimeter edges of inner surface 216a can be aligned with the circumferential edges of first surface 208a. In another example, an axial perimeter edge of inner surface 216a can be aligned with the axial end edge of the second end 208 of a spoke. In alternative embodiments, one or more perimeter edges of inner surface 216a can be positioned inside the perimeter edges of the first surface 208a of second end 208 such that one or more portions of first surface 208a are exposed and not covered by either the inner surface or outer surface of flexure member 216. In one or more embodiments, flexure member 216 can be provided as a rectangular cuboid and arranged so that an end of the flexure member 216 is aligned with the second end 208 of the spoke 200, set back from the second end of the spoke, or may be arranged so that an end of the flexure member extends beyond the second end of the spoke.

Flexure member 216 has a first width that extends along the axial direction of the tire, a second width that extends along the circumferential direction of the tire, and a height that extends along the radial direction of the tire. The axial and circumferential widths of the flexure member will vary along its height, and the height of the flexure member can vary along its axial or circumferential width.

Height (h) of flexure member 216, extending in the radial direction and measured between inner and outer surfaces 216a, 216b as shown in FIG. 4, forms a side perimeter surface 220. Height (h) of flexure member 216 can be constant in some embodiments, and also vary in other embodiments depending on the spoke surface geometry relative to an inner surface of the outer support ring. In one example, flexure member height can be constant in the axial direction and vary (e.g., increase from one circumferential end to the opposite circumferential end) along the circumferential direction. In another example, flexure member height can be the lowest at circumferential end of a spoke and increase (e.g., in a constant degree) moving away from the end of a spoke and radially inward such that the maximum height is achieved at the opposite circumferential end of the flexure member.

Circumferential and axial width of flexure member 216 varies in both the circumferential and axial directions along height (h) because side perimeter surface 220, side surface between inner and outer surfaces 216a, 216b, is filleted (e.g., around entire perimeter surface) or has two or more, three or more, four or more or five or more radiused face surfaces. The side perimeter surface, and faces thereof, can have any concave shape or combination of concave shapes, for example, elliptical, partial circular, or irregular. It is preferable that the shape of the filleted or radiused surfaces has a constant curvature or smooth tangent transition from the perimeter edge of 216a to the perimeter edge of 216b that forms the end points of the perimeter surface. The intersection of the perimeter faces and the perimeter edges of 216a, 216b form a stress building section and can result in fatigue cracking of flexure member 216 near its adhesion with a spoke. A filleted side perimeter surface 220 on multiple perimeter face surfaces or the entire perimeter face functions to distribute stresses along intersection points to the center area of flexure member 216 and reduce fatigue cracking.

The filleted faces of side perimeter surface 220 can have an inset distance. The inset distance is measured by determining the distance between a center waist portion of a perimeter face (i.e. the lowest width point) and an imaginary plane that extends from perimeter edge of 216a to perimeter edge of 216b at the end points of the perimeter face. The inset distance can be in the range of 0.2 to 2.5 times, 0.5 to 2.25 times, or 1 to 2 times the height of the imaginary plane that extends from perimeter edge of 216a to perimeter edge of 216b at the end points of the perimeter face.

Side perimeter surface 220 can be in non-contact with structural components of non-pneumatic tire 10 such that surface 220 is directly exposed to the surrounding environment (e.g., air). Side perimeter surface 220 can have any suitable shape and one or more sides, for instance, two to eight or more sides that form face surfaces that have face planes, for instance curved, radiused or concave shape face planes, facing or pointing in non-identical directions. In FIGS. 2 and 3, flexure member 216 is shown having side perimeter surfaces with a concave shape that extends between contact with the outer support ring 30 and spoke end 208.

The filleted or radiused face surfaces of the side perimeter surface form a center waist portion between the inner and outer surfaces, 216a, 216b such that the center waist portion has least circumferential width, axial width, or both widths. The circumferential and axial width increases in both directions from the center waist portion along height (h) such that the greatest circumferential and axial width radially inward and outward from the center waist portion occurs at the inner and outer surfaces 216a, 216b of flexure member 216.

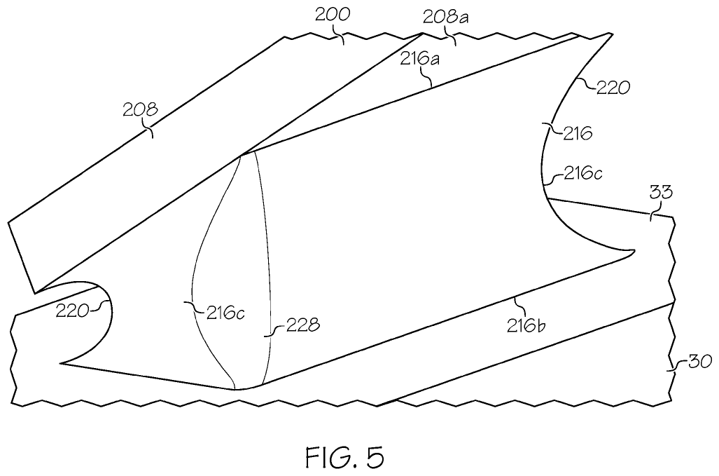

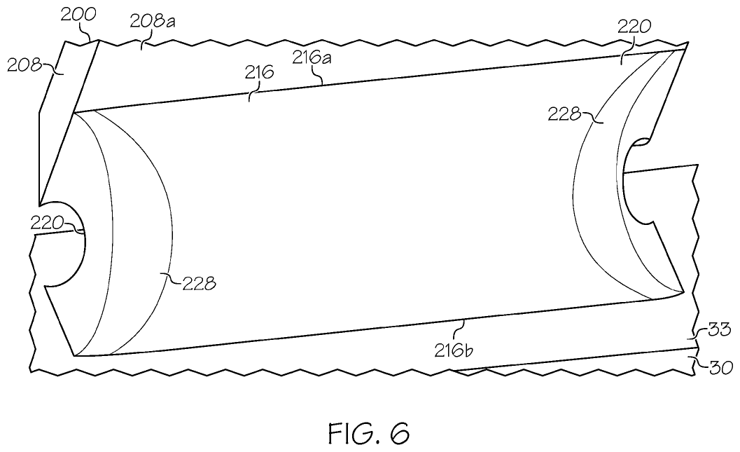

As shown in FIGS. 5 and 6, center waist portion 216c is at the midpoint of side perimeter surface 220 and the circumferential and axial widths of flexure member 216 continuously increase without a flat linear plane portion radially inward to internal surface 33 of outer support ring 30 and radially outward to first surface 208a of second end 208 of spoke 200. Although not shown, in an alternative design, the waist portion 216c may be near or adjacent to the center point of the side perimeter surface 220. The two circumferential perimeter surfaces of flexure member 216 are filleted and have a radiused face that extends from a circumferential perimeter edge of inner surface 216a to outer surface 216b. The two axial perimeter surfaces of flexure member 216 are filleted and have a radiused face that extends from an axial perimeter edge of inner surface 216a to outer surface 216b.

The center waist portion 216c represents the minimal diameter or width (axial or circumferential) of flexure member 216. Center waist portion 216c can have an average diameter, axial width or circumferential width in the range of 5 mm to 130 mm, 6 mm to 110 mm, 7 mm to 100 mm, 8 mm to 80 mm, 9 to 70 mm, or 10, 11, 12, 13 or 14 mm, or 20, 25, 30, 35, 40, 45, 50 or 60 mm. In other examples, the center waist portion 216c can have an average diameter, axial width or circumferential width of less than 25 mm, less than 20 mm or less than 15 mm and greater than 6 mm, greater than 7 mm or greater than 8 mm. In other examples, the center waist portion 216c can have an average diameter, axial width or circumferential width of more than 50 mm, more than 80 mm or more than 100 mm and less than 130 mm, less than 125 mm or less than 120 mm. The center waist portion 216c axial or circumferential width can be compared to the greatest axial or circumferential width located at the inner surface 216a and an outer surface 216b of flexure member 216. In one or more embodiments, the axial or circumferential width at the inner or outer surfaces 216a, 216b as compared to the axial or circumferential width at the center waist portion 216c can be in the ratio range of 0.5 to 8.5, 0.75 to 6.5, 1 to 5, 1.25 to, 4, or 1.5 to 2.5.

The circumferential and axial perimeter surfaces of flexure member 216 constitute four perimeter faces that can have a filleted surface. In certain embodiments, the circumferential and axial perimeter surfaces, or four perimeter faces, of flexure member 216 form the entire side perimeter surface 220 of the member. As depicted in FIG. 5, a filleted circumferential perimeter surface intersects with a filleted axial perimeter surface. The intersection of circumferential and axial perimeter surfaces can form one or more corners (e.g., 2, 4) along the filleted perimeter surface. The corners can have radiused curvature in the same shape as the intersecting circumferential and axial perimeter surfaces. The corner edges formed by the intersecting circumferential and axial perimeter surfaces can be softened by forming a corner side perimeter surface or face. FIG. 5 shows a corner side perimeter face 228 that transitions the circumferential and axial perimeter surfaces into a smoother perimeter face as compared to a sharp corner edge. The side perimeter surface 220 of flexure member 216 can have one or more corner side perimeter faces 228, for example, one, two, three or four corner side perimeter faces. The side perimeter surface 220 of flexure member 216, when including one or more corner side perimeter faces 228, can have five or more filleted perimeter surfaces, for instance, six, seven or eight filleted perimeter surfaces.

In another example, FIG. 6 shows a filleted circumferential perimeter face positioned between two filleted corner side perimeter faces 228 that are also each adjacent a filleted axial perimeter face of flexure member 216. The filleted corner side perimeter faces 228 extend with a continuous radiused surface between the perimeter edges of inner and outer surfaces 216a, 216b of flexure member 216. The filleted corner side perimeter faces 228 aid in reducing stresses imparted at attachment points at spoke ends 208a and, in some instances, reorient stresses away from bonding areas between spoke end 208 and internal surface 33 of outer support ring 30 to improve the durability of attachment points for flexure member 216.

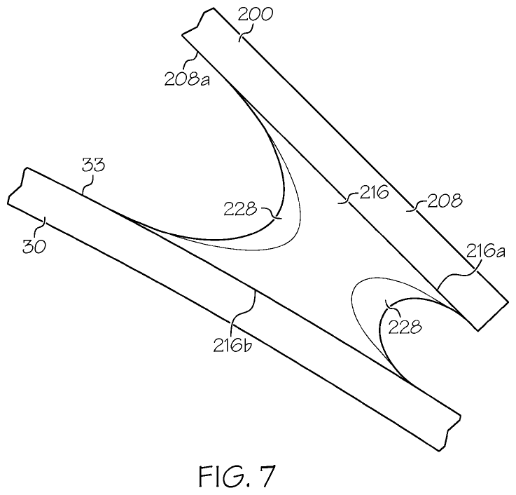

FIG. 7 shows a filleted axial perimeter face positioned between two filleted corner side perimeter faces 228 that are also each adjacent a filleted circumferential perimeter face of flexure member 216. The filleted corner side perimeter faces 228, like the circumferential and axial side perimeter faces, extend with a continuous radiused surface between the perimeter edges of inner and outer surfaces 216a, 216b of flexure member 216 that are respectively secured to first surface 208a of second end 208 of spoke 200 and internal surface 33 of outer support ring 30.

Flexure member 216 shown in the figures may be manufactured out of a polymeric material (e.g., urethane, resin, rubber), metals, or any other suitable material or combination of materials. Preferably, flexure member 216 is prepared using a material suitable for introducing (e.g., pouring) into a mold for forming the desired shape including the entire filleted side perimeter of flexure member 216. The material is flowable for injection or pouring into the mold, for example, a liquid urethane composition. The material is cured or hardened in the mold, for example, under heating conditions and then removed for use and securement to spoke 200 and outer support ring 30. Flexure member 216 can be cleaned to remove any mold release material residing on surfaces and grinding or sanding can be used to remove barbs, witness marks, mold parting lines, mold venting marks, or other irregularities resulting form the molding process.

Mold tooling used to form the flexure member 216 must be removed after the member is cured to reveal the finished part. For instance, mold tooling is disassembled into multiple parts along parting lines or joints to free the formed flexure member. The molding tooling can be made of multiple pieces such that the connection or mating point of the pieces and/or an injection point can imprint a mold parting line or other mark (witness mark) on the finished flexure member. Often at the mold parting lines there can be flash as well. The presence of mold parting lines or other marks in areas of high stress on the flexure member can impact the durability and performance of the part. In an example, mold parting lines can create small witness marks or imperfection in the surface that can act as a stress riser. As described above, the corner side perimeter faces 228 aid in reducing stresses imparted at attachment points at spoke ends and, in instances, reorient stresses away from bonding areas between spoke ends and internal faces of the outer support ring that improve the durability of attachment points for the flexure member. Molding tooling for forming the flexure member preferably includes less molding parts to reduce the amount of mold parting lines and other marks on the finished flexure member and/or selectively locating or positioning mold parting lines and other marks to be distanced away from areas of potential increased operating stresses. By positioning mold parting lines and other marks away from certain stress and strain areas of the flexure member, and thus the parting lines and other marks do not coincide with areas of potential high stress or high strain, these areas will not be negatively impacted by any additional surface imperfections that can give rise to an increase in stress or strain. In a similar manner, mold venting locations can provide a potential source of surface imperfections and should be positioned away from and avoided at areas of potential stress and strain in the flexure member.

In one or more embodiments, the flexure member is free of a mold parting line at or near any corner side perimeter face or filleted corner side perimeter face. In an example, any mold parting line on the flexure member is at least 5 millimeters (mm), at least 8 mm, at least 10 or at least 15 mm away from any corner side perimeter face or filleted corner side perimeter face of the flexure member. In another example, any mold parting line is located between or substantially centered between two corner side perimeter faces, for instance, on a perimeter surface or filleted surface. By centering a mold parting line or lines between two corner side perimeter faces, any potential surface imperfections imparted by the molding tooling are optimally spaced away from high stress and strain areas of the flexure member.

In another embodiment, the flexure member is free of a witness mark, flashing, or a mold venting mark at or near any corner side perimeter face or filleted corner side perimeter face. A witness mark, flashing, or a mold venting mark is spaced away from any corner side perimeter face or filleted corner side perimeter face of the flexure member, for example, at least 5 millimeters (mm), at least 8 mm, at least 10 or at least 15 mm away from any corner side perimeter face or filleted corner side perimeter face of the flexure member. In other embodiments, a witness mark, flashing, or a mold venting mark is located between to located between or substantially centered between two corner side perimeter faces, for instance, on a perimeter surface or filleted surface.

In one or more embodiments, the mold used to form flexure member 216 can include a component of a non-pneumatic tire as an internal wall of the mold. For example, a mold can include an opening that exposes flexure member molding material within the mold and a component of a non-pneumatic tire can be positioned to cover the opening or pre-assembled to close the opening prior to introduction of flexure member molding material in the mold cavity. The flexure member molding material directly contacts a surface of a component of a non-pneumatic tire or part thereof and bonds to the component surface during curing. As the cured flexure member is removed from the mold, it is secured to the surface of a component of the non-pneumatic tire. In other embodiments, the mold used to form flexure member 216 can include two components of a non-pneumatic tire as an internal wall of the mold. For instance, a mold can include two openings that expose the flexure member molding material within the remaining portion of the mold cavity to the two components of a non-pneumatic tire that are positioned to cover the openings or pre-assembled to close the openings prior to the introduction of flexure member molding material in the mold cavity.

The non-pneumatic tire component can be any suitable part, for example, a spoke or outer support ring. Use of a non-pneumatic tire component as a mold surface can reduce a downstream process step for attaching a surface of the flexure member to a component. The non-pneumatic tire component can be cleaned of debris or residue prior to being aligned with a mold structure for forming a molding surface to ensure suitable bonding or adhesion of the flexure member molding material to the surface of the non-pneumatic tire component (e.g., an end surface of a spoke and/or internal surface of outer support ring). In one example, a spoke end surface is used as a mold surface that forms inner surfaces 216a such that the spoke end 208 is adhered to flexure member 216. To enhance adhesion, the spoke end surface serving as a mold surface can be primed with an adhesion aid, for instance, an epoxy adhesive or Chemlok® product. The spoke with flexure member 216 attached thereto can then be secured to an outer support ring 30 during assembly of a non-pneumatic tire. In another example, an internal surface 33 of outer support ring 30 is used as a mold surface for bonding the flexure member molding material to the outer support ring.

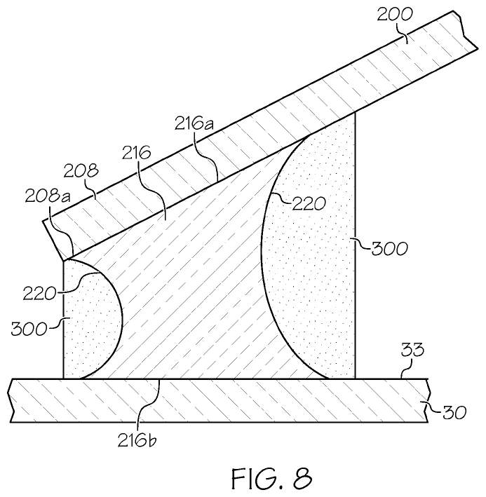

In one or more embodiments, the flexure member 216 can include protective material around its perimeter surface. As shown in FIG. 8, flexure member 216 has inner and outer surfaces 216a, 216b and a side perimeter surface 220 having circumferential radiused face surfaces that curve inward from the perimeter edges of surfaces 216a, 216b. The radiused face surfaces of perimeter 220 form concave sections around the side perimeter. The concave sections can be filled in with a filler material 300. Filler material 300 can be any suitable material, for example, a material different than that used to make flexure member 216. Filler material 300 is preferably a flexible, soft material that does not significantly interrupt any movement or flexing motions of flexure member 216. Filler material 300 can be added to the concave sections formed by the radiused face surfaces of perimeter 220 after flexure member 216 has been secured to spoke 200 and outer support ring 30.

Filler material 300 forms a barrier between the surface of side perimeter 220 and the outside environment surrounding the non-pneumatic tire and protects flexure member 216 from debris and environmental exposure. For instance, filler material 300 can reduce or eliminate debris that can otherwise contact and damage the side perimeter surface 220 during operation of the non-pneumatic tire. Foreign objects (e.g., rocks) can impact side perimeter surfaces of flexure member 216 and significantly damage filleted faces that serve to distribute stresses during operation. Cuts, cavities, or similar damage can form weak points along the side perimeter surface 220 of flexure member 216. The filler material can further reduce direct exposure of side perimeter surface 220 to noxious gases, sunlight and damaging ozone or other pollutants during operation. These protections can result in longer and more durable life of flexure member 216.

FIG. 8 shows filler material 300 extending past the concave sections formed by the radiused face surfaces of perimeter 220 and onto first surface 208a of second end 208 of spoke 200 and internal surface 33 of outer support ring 30. In an alternative arrangement, filler material 300 can cover or coat the side perimeter surface 220, for instance as a layer, that provide an external protection surface. In another example, filler material 300 can entirely fill the concave sections formed by the radiused face surfaces of perimeter 220 but not extend onto or significantly contact first surface 208a, internal surface 33, or a both surfaces. In this instance, filler material 300 can form a linear or flat surface on the side perimeter surface 220 of flexure member 216.

While various aspects and embodiments of the compositions and methods have been disclosed herein, other aspects and embodiments will be apparent to those skilled in the art. The various aspects and embodiments disclosed herein are for purposes of illustration and are not intended to be limiting, with the true scope and spirit being indicated by the claims.

1. A non-pneumatic tire comprising
an outer support ring;
an inner support ring positioned inside the outer support ring;
a support structure positioned between the outer support ring and the inner support ring, the support structure comprising a spoke, the spoke comprising:
a first end secured to the inner support ring;
a second end secured to a flexure member, the flexure member comprising an inner surface, an outer surface, and a filleted perimeter surface.

2. The non-pneumatic tire of claim 1, wherein the inner surface of the flexure member is secured to the second end of the spoke and the outer surface of the flexure member is secured to the outer support ring for securing the second end of the spoke to the outer support ring.

3. The non-pneumatic tire of claim 1, wherein the filleted perimeter surface is positioned between the inner surface and the outer surface of the flexure member.

4. The non-pneumatic tire of claim 1, wherein the flexure member is positioned between the second end of the spoke and the outer support ring, and the second end of the spoke is free of contact with the outer support ring.

5. The non-pneumatic tire of claim 1, wherein the filleted perimeter surface has a concave shape.

6. The non-pneumatic tire of claim 5, wherein the concave shape of the filleted perimeter surface is continuous without a flat linear plane portion from the intersection with the inner surface to the intersection with the outer surface.

7. The non-pneumatic tire of claim 5, wherein the concave shape of the filleted perimeter surface comprises a flat linear portion near a center waist portion.

8. The non-pneumatic tire of claim 6, wherein the concave shape has a circular radius or elliptical arc.

9. The non-pneumatic tire of claim 1, wherein the filleted perimeter surface comprises substantially all of the outer surface of the flexure member between the inner surface and the outer surface of the flexure member, and the filleted perimeter surface of the flexure member comprises two or more faces having a filleted surface.

10. The non-pneumatic tire of claim 9, wherein the filleted perimeter surface of the flexure member is comprised of four or more faces having a filleted surface.

11. The non-pneumatic tire of claim 9, wherein the two or more faces of the filleted perimeter surface of the flexure member intersect with one another to form a corner along the filleted perimeter surface, the corner of the filleted perimeter surface being a filleted corner face.

12. A flexure member for a non-pneumatic tire, the flexure member comprising:
an inner surface having a plane;
an outer surface having a plane; and
a side perimeter surface arranged between the inner surface and the outer surface, the side surface extending around the entire perimeter of the flexure member, the perimeter side surface comprises two or more radiused face surfaces.

13. The flexure member of claim 12, wherein the plane of the inner surface comprises a plurality of perimeter edges that form three or more connection points where the perimeter edges intersect one another, and the three or more connection points along the plane of the inner surface are in contact with a portion of a radiused concave surface of the side perimeter surface of the flexure member.

14. The flexure member of claim 12, wherein the plane of the outer surface comprises a plurality of perimeter edges that form three or more connection points where the perimeter edges intersect one another, and the three or more connection points along the plane of the outer surface are in contact with a portion of a radiused concave surface of the side perimeter surface of the flexure member.

15. The flexure member of claim 12, wherein the two or more radiused concave surfaces have a circular shape, an elliptical shape, a parabolic shape, or a combination thereof.

16. The flexure member of claim 12, wherein the two or more radiused face surfaces are concave surfaces.

17. The flexure member of claim 12, wherein the two or more radiused face surfaces each comprise a first end and a second end, the first end intersects with a perimeter edge of the inner surface of the flexure member and the second end intersects with a perimeter edge of the outer surface of the flexure member.

18. The flexure member of claim 12, wherein the side perimeter surface comprises four face surfaces that define the perimeter of the flexure member between the inner surface and the outer surface, each of the four face surfaces have a concave shape and intersect to form four corners along the side perimeter surface, the four corners of the side perimeter surface each being a filleted corner side perimeter face.

19. The flexure member of claim 18, wherein each of the four face surfaces are radiused.

20. The flexure member of claim 12, wherein the inner surface of the flexure member is secured to a spoke of the non-pneumatic tire and the outer surface of the flexure member is secured to an outer support ring of the non-pneumatic tire.
